(19) United States
(12) Patent Application Publication
(10) Pub. No.: US 2003/0216117 A1
(43) Pub. Date: Nov. 20, 2003

(54) Method of treating shellfish

(76) Inventor: Stephen John Edwards, Trevallyn (AU)

Correspondence Address: RATNERPRESTIA, P O BOX 980, VALLEY FORGE, PA, 19482-0980, US

(21) Appl. No.: 10/425,438

(22) Filed: Apr. 29, 2003

(30) Foreign Application Priority Data
Apr. 29, 2002 (AU) PS2010

(51) Int. Cl. A22C 29/02

(52) U.S. Cl. 452/1; 119/204; 452/12; 119/234

(57) ABSTRACT

A method of processing abalone is disclosed. The first step involves placing live abalone in a tank of water where they are given an opportunity to de-stress. Thereafter the salinity of the water is decreased to about 2.5%. This has the effect of additional weight being taken up on the musculature of the abalone. Thereafter the abalone are anaesthetised in the tank to minimise any muscular activity during subsequent processing. The abalone are then taken out of the tank and shucked to detach the meat or musculature from the shell and gut exposing the three main blood vessels of the abalone. These blood vessels are then blocked by inserting a blocking material into the open end of the vessel where it forms a plug. This resists the flow of body fluid including blood out of the abalone and assists in retaining the weight of the meat. After the meat has been cleaned a liquid is injected into the meat typically by a multipoint injector. This inserts a hygroscopic or humectant material deep into the meat that resists the loss of fluid out of the meat during the cooking process. These three steps both individually cumulatively cause an increase in yield of abalone meat from a unit mass of abalone when compared with convention processing techniques. In view of the high price of abalone this has a high economic worth.

### FIELD OF THE INVENTION

This invention relates to a method of treating shellfish. More specifically this invention relates to a method of treating shellfish after they have been harvested and before they are packed for distribution and sale.

In this specification the term shellfish is to be interpreted to comprise marine animals that have a shell but to exclude crustaceans, crabs and the like.

This invention relates particularly but not exclusively to the treatment of abalone and it will be convenient to hereinafter describe the invention with reference to this example application. However it is to be clearly understood that the invention extends to other shellfish including oysters, scallops, sea cucumbers and molluscs such as mussels.

### BACKGROUND TO THE INVENTION

A variety of marine animals such as those mentioned above are harvested by commercial fishing operations at sea and then processed for sale in both domestic and foreign markets. The product is sold on a weight basis which is expressed as a certain price per kilogram. It is advantageous to retain as much protein and body fluid and thereby weight within the product meat as possible. The price of the meat is based directly on the weight of meat that is placed in cans at the end of the processing (in can weight) and this is carefully monitored. A small increase in weight can substantially increase the profitability of this economic endeavour.

Previously not much attention has been paid to the processing of shellfish such as abalone after they have been offloaded at a processing plant and up to canning of the product meat in a final packaging operation. Clearly it would be advantageous if a way could be devised of improving this process and in particular improving the yield of meat obtained from a unit weight of incoming shellfish. It would also be advantageous if a way could be found of improving even slightly the tenderness of the meat.

### SUMMARY OF THE INVENTION

According to one aspect of this invention there is provided a method of processing shellfish at a processing plant after the shellfish have been caught and transferred to land, the method comprising:

receiving a plurality of shellfish at the processing plant;

placing the shellfish in a body of water having a salinity comparable to that of sea water for a first period of time that enables the shellfish to substantially de-stress;

reducing the salinity of the water making up said body of water;

keeping the shellfish in said body of water for a further period of time;

whereby said reduced salinity in said sea water acts to effect an increase in the weight of meat of said shellfish prior to killing said shellfish and preparing said meat for packing.

Thus the reduction in salinity of the water has the result that the weight of the meat or muscle tissue of the abalone is increased.

Without being bound by theory Applicant believes that the reduction in salinity may alter the internal metabolism or functioning of the shellfish in a way that results in an internal redistribution of body fluid and protein between the gut of the shellfish on the one hand and the meat or musculature of the shellfish on the other hand. In addition the reduction in salinity may possibly result in an increased uptake of water in the shellfish by osmosis. Applicant believes that the stress reduction step prior to lowering of the salinity has the effect that the shellfish direct more blood flow to the muscle than if the salinity of the water was lowered while they were still stressed. Applicant believes that the physiology of the abalone may substantially shut off blood flow to the muscle under stress.

The shellfish are alive when they are subjected to the process of reduction in salinity. The enables changes in the internal metabolism of the shellfish to influence the process.

The shellfish may be given a time period of at least 30 hours to de-stress on arrival at the processing plant. Advantageously the shellfish are given a time period of 3 to 4 days (or 72 to 96 hours) within which to adjust to conditions in the processing plant and de-stress. The behaviour pattern whereby the shellfish attach to a side of the tank, typically after a period of 15 to 20 hours is an indicator that they have de-stressed.

Typically the body of water comprises a tank of water in which the shellfish is received. The salinity of water may be reduced by adding an appropriate amount of fresh water to the water recirculated through the tank.

The salinity of the water circulated through the tank may be reduced from 3.5% (normal salinity of sea water) to 2 to 3%. Advantageously the salinity of the water recirculated through the tank is reduced to about 2.5%. This reduction in salinity may be implemented gradually such that it takes about 1 hour and 30 minutes for the salinity to be reduced.

The shellfish may be retained in said body of water of reduced salinity for 10 to 30 hours, preferably 16 to 28 hours, e.g. about 22 to 24 hours. During this period the weight of the meat of the shellfish increases progressively. This uptake of water occurs more quickly at first and then more slowly. Applicant has determined that a satisfactory level of weight gain will take place within a time period of 22 to 26 hours and after this time period weight gain tends to level out.

In addition the meat of the shellfish becomes softer the longer it is held in water of reduced salinity. If the meat is softened beyond a certain point it can make processing difficult.

The shellfish may be anaesthetised in the body of water before they are removed from the tank for further processing.

According to another aspect of this invention there is provided a method of processing a shellfish having a shell, a gut and a meat or musculature to yield the meat of the shellfish, the method comprising:

providing at least one shellfish for processing;

removing the meat of the shellfish from its associated shell; and

closing off at least one major blood vessel so as to resist leakage of fluid from said shellfish through said blood vessel.

The blood vessel may be blocked by inserting a blocking material into the end of the blood vessel where it forms a plug. Alternatively the vessel may be blocked by cauterising the vessel or by application of a ligature or a tourniquet around the vessel and/or meat around the vessel.

Where the shellfish is an abalone having three major blood vessels, the method includes exposing three major blood vessels of the abalone by removing the neck with a hand held implement. These comprise one vein and two arteries which come together close to the neck of the shellfish. The vessels are arranged in the form of a triangle when viewed end on. One vein is at the top and there are arteries on each side of the vein below the vein.

In one form the inserting step comprises inserting blocking material into each of the three major blood vessels.

The method may further include anaesthetising the shellfish prior to the step of removing the meat of the abalone from the shell. This induces relaxation of the musculature of the fish before the blocking step is carried out.

The shellfish may be anaesthetised by carbon dioxide, magnesium salts, clove oils, chilli extract and food compatible electric shock treatment.

Further alternatively the step of anaesthetising the shellfish may be accomplished by par cooking them at low temperatures such as 35 to 50° C. Yet further alternatively the step may be accomplished by chilling the fish to kill them followed by warming.

Conveniently the method may include injecting a settable material as the blocking material into the blood vessel where it forms a plug. The settable material may conveniently be meat of the shellfish being treated, e.g. for abalone this could be homogenised or minced abalone meat.

Applicant believes that it is advantageous to use abalone meat as the blocking material product as this would not amount to an additional foreign component within the finished product.

Alternatively the settable material may be a non shellfish material, e.g. a protein mixture or an inert rubber or plastic material, e.g. neoprene, that has to be removed by the purchaser prior to consumption.

Typically the step of removing the meat from the shell includes shucking the shellfish prior to the step of exposing the blood vessels, e.g. in a manual operation using a hand held implement.

Typically the step of exposing the blood vessels involves removing the neck of the shellfish, e.g. with a hand held implement in a manual operation.

Preferably the blocking material is inserted into the shellfish as soon as possible after shucking has taken place.

The plug of blocking material resists the loss of body fluids out of the blood vessel subsequent to shucking. It therefore assists in retaining body fluid within the meat product that is sold thereby maximising the weight of the meat product sold.

The step of physically blocking the blood vessels may be carried out by an injector, capable of injecting material into the blood vessels at high pressure. Preferably the injector has a male end region of reduced diameter relative to the rest of the injector and an outwardly tapering region axially inwardly of the male end region. This enables the tapering region to abut the end of the blood vessel and the end of the male end region to be spaced a distance up the blood vessel.

The invention also extends to the injector used in the process.

According to yet another aspect of this invention there is provided a method of processing abalone meat after it has been shucked and prior to canning of the meat, the method comprising injecting liquid into the meat at at least one injection site.

The step of injecting typically occurs after blanching and cleaning of the shellfish, and prior to canning of the shellfish. The liquid may be injected several hours, e.g. 12 or more hours, before canning of the shellfish. This time allows the liquid to diffuse through the meat before the canning process. Alternatively the liquid may be injected immediately before the canning process.

The liquid may be injected at a plurality of injection sites, e.g. at one time. The fish may be injected with material at more than ten sites arranged in the form of a matrix, with each of the sites being spaced 3 to 5 mm away from each other.

The injecting step may be carried out with a multiple injector, e.g. having a plurality of spaced injection needles. This enables all sites to be injected simultaneously, e.g. in a quick one step operation.

Alternatively the liquid may be injected a plurality of times at a single entry site with multiple angles of passage.

The meat may be injected with a hygroscopic (water seeking) liquid, e.g. sorbitol. The meat may also be injected with a humectant (water holding) liquid, e.g. sorbitol, gelatine, agar or starch. Preferably this liquid is injected deeply into the meat so that it is centrally located within the depth or thickness of the meat.

The meat may also be injected with a liquid having a pH and/or salts that promote the precipitation of protein as a gel within the meat. The precipitation of the protein as a solid promotes its retention within the meat during the cooking process rather than its leakage out of the meat. The cooking process tends to cause a breakdown of protein in the meat increasing the tendency of protein to move out of the meat and into the canning solution. The addition of the injected liquid causes a reverse osmotic effect tending to retain water, protein and salts within the meat.

In addition the gelatinised protein which is retained within the meat also acts as a humectant. The retained protein carries with it a certain amount of associated salts which act to hold water as a surrounding solvent shell.

Thus dry matter in the form of protein and salt is retained in the meat during the cooking process in addition to water. The final product differs little from the meat canned using conventional processing techniques in its percentage of water content.

Where large holes are made in the meat during the injection process they may be blocked by blocking material of the type that is used for blocking the blood vessels described above in the second aspect of the invention.

The method described above with reference to the second aspect of the invention may be combined with the method described above with reference to the first aspect of the invention.

Thus the step of reducing the salinity of water in the recirculating tank may be combined with the step of blocking the blood vessels of the shellfish once it has been removed from the shell. That is a reduction in salinity can be combined with blocking of the blood vessels.

This method combining both the first and second aspects of the invention may further include one or more of the preferred or optional features of both the first and second aspects of the invention described above.

Yet further the method of treatment may further include the method set out in the third aspect on the invention described above.

According to yet another aspect of this invention there is provided a method combining the method described above with reference to the first aspect of the invention and the method described above according to the third aspect of the invention.

Thus the step of reducing the salinity in the holding tanks may be combined with the multi point injection step prior to canning and cooking. The step of blocking may not be suitable on some shellfish with different circulatory systems to abalone. In such cases the other aspects of the invention may be employed to retain as much weight in the meat as possible.

According to yet another aspect of the invention there is provided a method of combining the method described above with reference to the second aspect of the invention with the method described above with reference to the third aspect of the invention.

Thus the step of blocking the blood vessels may be combined with the step of multi point injection before the meat is cooked and canned. Both steps will resist the outflow of body fluids.

### DETAILED DESCRIPTION OF THE PREFERRED EMBODIMENT

A method of treating or processing shellfish after they have been harvested and prior to canning in accordance with this invention may manifest itself in a variety of forms. It will be convenient to hereinafter provide a detailed description of one embodiment of the invention with reference to the accompanying drawings. The purpose of providing this detailed description is to instruct persons having an interest in the subject matter of the invention how to put the invention into practice. It is to be clearly understood however that the specific nature of this detailed description does not supersede the generality of the preceding statements. In the drawings:

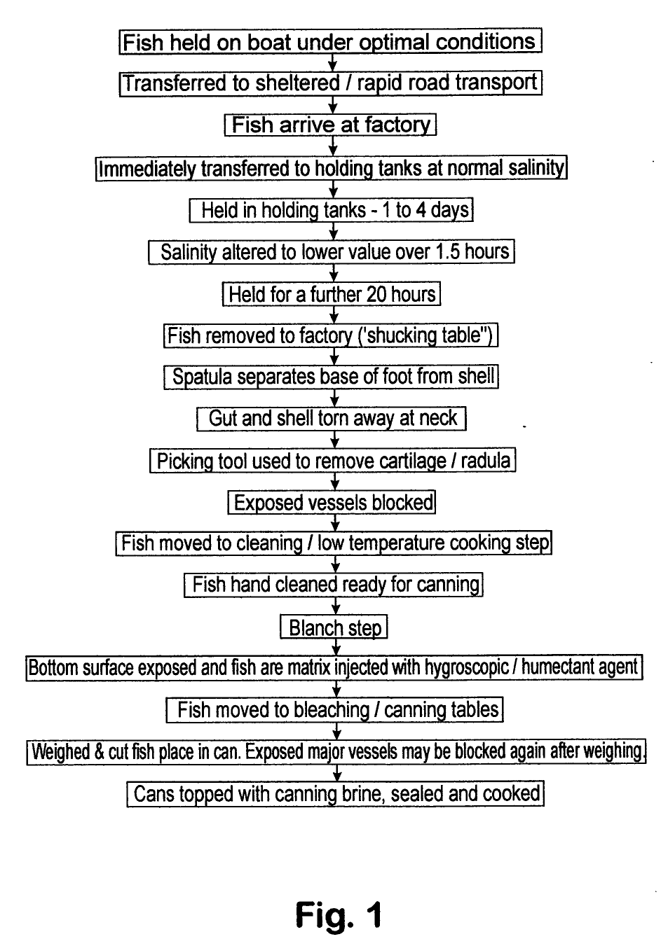

FIG. 1 is a flow sheet of the overall process of treating abalone;

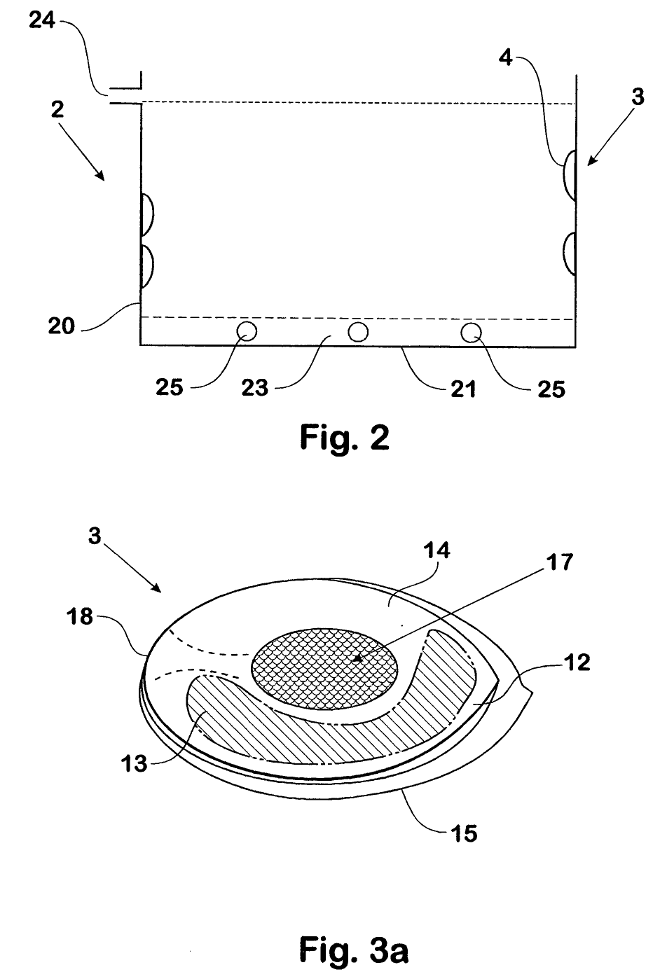

FIG. 2 is a schematic cross sectional front view of a holding tank for the process of FIG. 1;

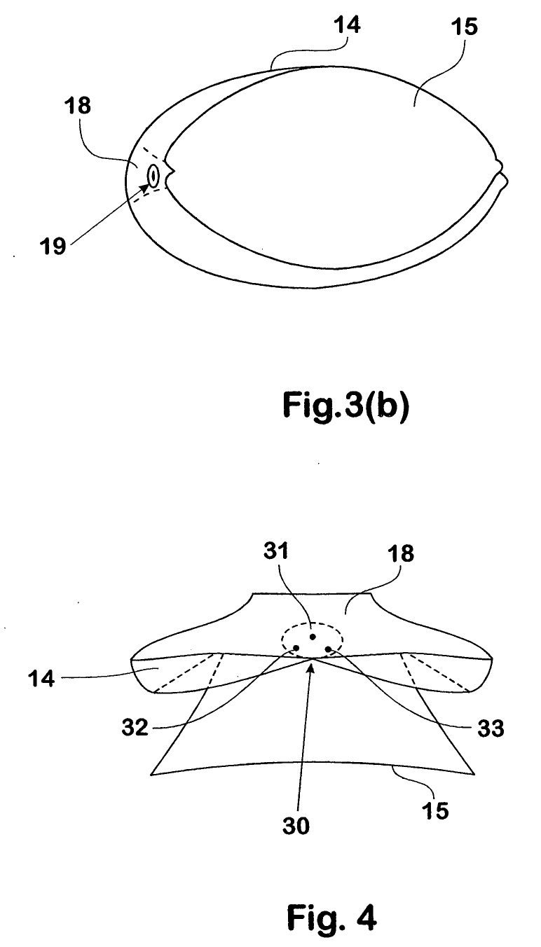

FIG. 3a is an upper three dimensional schematic view showing the various body parts of an abalone out of its shell;

FIG. 3b is a lower three dimensional view of the abalone of FIG. 3a;

FIG. 4 is a schematic three dimensional view of part of an abalone showing the three major blood vessels that are blocked off during processing;

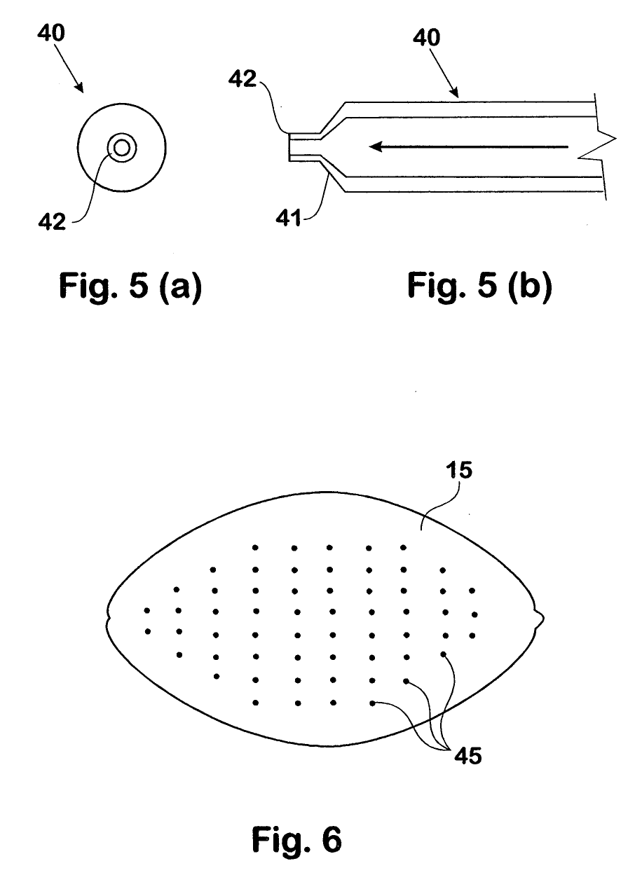

FIG. 5a is a front view an injector used to perform the blocking of the blood vessels;

FIG. 5b is a sectional side view of the injector; and

FIG. 6 is a bottom plan view of a piece of abalone meat showing a pattern of multiple injection in the meat.

The detailed description below describes the treatment of shellfish that are abalone.

An abalone 3 is like a snail. It has a shell 4 protecting its meat or musculature 14 and an opening at the bottom of the shell through which a foot 15 projects. The shell 4 is shown in FIG. 2 but is not shown in the drawings of the general anatomy of the abalone 3. The foot 15 attaches the abalone 3 directly to a support surface.

FIG. 3a shows an upper three dimensional view of an abalone. The body has a mantle across its top with a central point of attachment 17 to the shell 4. However in this drawing the gut and the mantle have been removed and the frill is pushed to one side to show the underlying musculature.

The upper side of the frill is shown by the reference numeral 12. Further the area normally occupied by the gut and gills is indicated by numeral 13.

FIG. 3b shows a lower three-dimensional view of the abalone 3. The degree of overlay of muscle and frill varies from one fish to another and from one species to another. FIG. 3b shows the base of the foot 15 and the underside of the frill. The abalone 3 has several major blood vessels but overall the circulatory system is quite primitive. It also shows a muscular neck 18 with a mouth 19 positioned on the underside thereof. The abalone 3 has several major blood vessels. However overall the circulatory system is quite primitive and there are not many small blood vessels within the meat of the abalone.

FIG. 1 shows a flow sheet of the various processing steps that take place when the shellfish arrive at the processing plant.

The abalone 3 are first of all placed in holding tanks 2 filled with water where they are given time to de-stress. Thereafter the salinity of the water in the tank 2 is reduced to promote the uptake of water in the abalone meat and thereafter the abalone 3 anaesthetised.

After the abalone 3 are removed from the holding tanks 2 they are shucked. This involves opening up the shell 4 by inserting a spatula (not shown) between the shell 4 and the meat 14. Thereafter the meat 14 of the abalone is detached from the shell 4. The abalone has a gut (not shown) under the shell 4 most of which remains behind with the shell 4 when this detachment takes place. The meat 14 is then subjected to the next step of processing which is blocking of blood vessels 30. Typically this is accomplished by inserting a plug of blocking material which is minced abalone meat into the vessel. Advantageously the meat is blocked immediately after shucking and prior to placement in bins.

The meat 14 is blocked manually by an operator on a blocking surface. After blocking the meat is placed in a rotating drum for cleaning. After this mechanical cleaning step the meat is hand cleaned by operators using a brush and metal scraper. The meat is then blanched with a blanching agent.

After this step the meat 14 is injected with liquid using a multiple point injector (not shown). This injects a hygroscopic liquid deep into the flesh of the meat 14 to assist in the retention of protein and body fluid during the cooking process. A low temperature cook occurs sometimes prior to the injection step. Thereafter the meat is canned in the usual way for distribution and sale at a canning station.

The various steps in the processing of the abalone will now be described in turn in some detail.

When the abalone 3 arrive at the processing plant they are placed in holding tanks 2. FIG. 2 shows a sectional front view of such a holding tank 2. The tanks 2 are typically square/rectangular and filled with salt water having a salinity approximating that of salt water in the sea, e.g. about 3.5%. Water is recirculated through the tanks 2 by means of pumps. The tanks 2 generally have four side walls 20 and a floor 21. The abalone generally attach themselves to the side walls 20 of the tanks 2. A mesh 23 may be placed on the floor of the tanks 2. The abalone do not like attaching themselves to the mesh 23 and therefore this encourages them to move onto the side walls 20. Generally the movement of substantially all of the abalone onto the side walls 20 of the tank 2 is a sign that they have fully de-stressed and are ready for further processing. Applicant has established that it takes about 20 to 96 hours for the abalone to acclimatise themselves to their new surroundings and de-stress, e.g. 3 to 4 days. The tank 2 also has a water overflow pipe 24 and inlet pipe 25 positioned towards the bottom of the tank 2.

However at the same time it should be appreciated that there will always be a small number of abalone 3 that do not recover their equilibrium in the tank and de-stress. This is indicated by a lack of movement towards the side walls. There will always be some attrition or recidivism.

Once the abalone 3 have been suitably de-stressed, the first active step of the process is commenced. This first step involves reducing the salinity of the salt water in the holding tanks 2. This is done by adding fresh water to the water being recirculated to the tanks 2 through a closed system. Typically the salinity of the water is reduced from 3.5%, the normal salinity of sea water, to about 2.5%. This reduction in salinity is effected over a time period of about 1½ hours. The abalone 3 are then maintained in this low salinity environment for about 20 hours before being processed further on an individual basis.

The effective reduction of salinity in the holding tank 2 is that increased mass is taken up by the flesh or meat 14. This adds weight to the meat 14 of the abalone which leads an increased yield of meat product. The product is sold on a per unit weight basis. Typically increased yields of 1.7 kilograms per carton of canned meat over prior art processing techniques can be obtained by this step. Applicant has found that the increase in body mass occurs quickly at first and then tapers off to a substantially slower rate. Based on this the applicant considers that an optimal treatment time in the reduced salinity environment is about 20 hours.

In addition to the increased mass of the meat 14 described above, the meat 14 treated in this fashion is slightly more tender than untreated meat 14. It is also of a lighter colour. Both of these properties are perceived as desirable by the customer and therefore enhance the quality of the product.

The Applicant's experimental work shows that only a relatively modest percentage of the weight gain as a result of the treatment is represented by water gain. The dry mass of treated meat is greater than it would have been if the shellfish was not treated by this process. This additional dry weight is made up of degraded muscle protein and salts. Applicant has conducted experiments to determine the extent of the increase in weight of the abalone that is due to water content alone.

Applicant found that an increase of weight of about 4% for one particular batch of abalone was achieved. Of this weight increase only 3.25% of the weight gain could be attributed to an increase in water content. Without being bound by theory Applicant believes that this may be due to an alteration in the physiology of the fish and in particular increased blood flow into the muscle of the abalone. This may also include a change in the conformation of certain structural proteins, e.g. an expansion thereof, due to the reduced salinity environment.

The importance of de-stressing the abalone prior to the reduction in salinity cannot be underestimated. An abalone will tend to be stressed if it is passed directly from an air environment to a low salinity water environment. If the abalone are still in a stressed condition when the salinity of the water is lowered they may alter their pattern of blood flow within their bodies and direct blood flow to the gut. This will have the result that blood flow to the meat, e.g. the muscle mass, is reduced. The gut region is lost when the fish is shucked and therefore the weight of this redirected blood will be lost from the meat which forms the final product.

After the abalone has been kept in the reduced salinity environment for 20 hours or so they are anesthetised by the application of food grade anaesthetic such as magnesium salts, clove oils, AQUIS™ or food compatible electric shock treatment or by bubbling food grade carbon dioxide through the water using a fine diffuser.

Other water circulation is stopped during this process so as not to dilute the effect of the added carbon dioxide. Bubbling is continued until the abalone 3 fail to hold on to the side of their holding tank 2 and otherwise stop movement. In normal operation a number of the abalone 3 will persist on the sides of the tank 2 after around 0.5 to 1 hour. They are able to do this by shutting down circulation to some parts of their body and switching to anaerobic metabolism. They are capable of maintaining this state for many hours and if left will not anaesthetise in an economical time. Those abalone are gently removed from the side of the tank 2 using a spatula and allowed to fall to the base of the tank 2 where they must engage in muscular motion for escape behaviour or righting behaviour. This action requires blood circulation and these abalone are then reliably anaesthetised within a further 0.5 hours.

Anaesthetised abalone show no motion at all during the subsequent shucking and processing procedures and generally do not bleed through the open blood vessels. This is because contraction of the muscle mass is inhibited by the anaesthetic.

The next step in the process involves shucking the abalone 3 individually. This involves inserting a spatula (not shown) between the shell 4 and the meat 14 and then levering the meat 14 out of the shell 4. At the same time any attachment ligaments attaching the meat 14 to the shell 4 are ruptured. The gut or the abalone is positioned adjacent the shell 4 beneath the meat 14. Most of the gut remains behind in the shell if the shucking is performed by a skilled operator. This is a desired outcome as the gut does not form the product meat that is sold. This shucking process therefore provides a block of meat 14 that can be processed further and then canned to form the final meat product.

After shucking a further manual step is performed in that a neck region 18 of the fish is cleaned to provide an open access to the major blood vessels 30 of the abalone. A front view of a shucked abalone showing the exposed neck is shown in FIG. 4. There are three blood vessels adjacent each other in proximity to the exposed neck region 18. These blood vessels form a triangle with a central vein 31 at the top and arteries 32 and 33 on either side of the vein 31 and below the vein 31. Each of these blood vessels 30 opens to the exterior as a result of removal of the neck 18.

The vessels therefore provide an opening through which body fluid, e.g. blood, can issue or drain from the meat and thereby result in a loss of weight from the meat.

The blood vessels 30 are the major route for fluid to leave the meat during cooking and handling of the meat. This can easily be seen by squeezing a cooked or par cooked abalone which causes fluid to issue from the open ends of the blood vessels. This skin of the abalone and also the abalone meat is relatively impermeable to the passage of fluid there through at normal temperatures.

The next step of the processing involves blocking the veins and arteries 30 with a blocking material. Alternatively the vessels 30 may be cauterised. Further alternatively the meat around the vessel approximate to the neck may be tied to block off the vessels 30. These latter two methods are not however explained in detail in the specific description.

The blocking is effected by means of an injector 40, e.g. an injection nozzle as shown in FIGS. 5a and 5b. The injector 40 has an inwardly tapering region 41 spaced inwardly in from the end of the injector 40 and a male region of reduced diameter 42 at the end of the injector 40. The tapering region 41 presses against the open ends of the blood vessels 30 and the blocking material that comes out of the end of the male region is placed some distance inside the vessels 30. The plug of blocking material fits tightly into the vein where it is held by a friction fit and blocks the flow of body fluid out of the vessel.

The blocking material may conveniently comprise minced abalone meat. Cooked abalone meat binds extremely well to itself forming a tight plug that is relatively impermeable to fluid flow. The advantage of using abalone meat is that it is not a foreign material. This considerably simplifies the listing of contents that inevitably have to be provided to a consumer of this food product.

Other materials such as protein or flour mixes or plastic or rubber substances such as neoprene may also be used.

The anaesthetising of the shellfish reduces muscle activity proximate to the blood vessels and this lessens the likelihood of the plug of blocking material being forced out of the vessels during subsequent processing. It makes it easier to keep the plugs in the vessels.

The next step involves cleaning the blocked meat in a centrifugal washing machine. The temperature of the washing machine is maintained at about 43-50° C. causing an outermost pigment layer of the meat 14 of the abalone 3 to detach from the remainder of the meat. After the meat 14 is removed from the washing machine final spot removal of the pigment layer is effected manually by means of an operator. The meat is then blanched to soften the meat in the usual manner of processing abalone.

The penultimate step in the treatment process involves injecting the meat using a matrix of fine needles (not shown). Each of these needles injects a material which either attracts or holds water in the meat. FIG. 6 shows an example pattern of injection sites 45 in the base of the foot 15 of the abalone 3. The front of the abalone is on the left side and the rear of the abalone is on the right side in this drawing. Generally the needles are not injected into the thin edges of the musculature.

The canning solution is different in osmolality to the fluid within the meat. There would therefore normally be an equilibrium driving force for water to move out of the meat and into the canning solution during the cooking process. However the addition of the sorbitol assists in resisting or reducing this effect. The sorbitol thereby resists the outflow of water from abalone meat during the cooking process.

The entrance holes made by the needles seal up as the meat is being cooked in the next step of the process. They cannot easily be detected by consumers and therefore do not detract from the quality of the final product.

Thereafter the meat is cut into pieces if this is required, weighed and then placed into cans in a normal canning operation. The cans are then topped up with brine and sealed and cooked in hot water for a period of 45 minutes. While canning is the currently envisaged form of containerising the meat for distribution and sale other options are not excluded.

Optionally the blood vessels may be blocked again after the meat has been cut into pieces if any major vessels are exposed. The price obtained by the abalone is determined by the mass of the meat that is placed in the cans and also the weight of the meat remaining in the cans after a cooking process. The post cooking weight is measured by taking a few representative cans from each batch and weighing the meat in these. The actual mass of meat in the final product is monitored very carefully by purchasers and cannot be overstated.

An advantage of the processing method described above is that it has the potential to enable increased yields of meat to be obtained from an amount of abalone, and thereby obtain a greater purchase price per unit product. The salinity tests reliably indicated increased yields of in can cooked meat weighs 9% better than the control runs. Similarly blocking the blood vessels reliably increases the yields of meat 8% above that for the control runs. Applicant believes that an increased body weight of at least 20% is eminently achievable using the method described above. Each of the aspects of the invention described above on its own has the ability to provide significant yield increases and cumulatively the three aspects have the potential for enormous gains.

In essence the lowering of the salinity in the body of water has the effect of increasing the physical size of the meat on the abalone while it is still alive. The blocking of the blood vessels after the meat has been removed assists in retaining this increased size by resisting the flow of fluid out of the meat. The injection of hygroscopic and humectant liquids assists further in reducing the loss of weight during the canning and cooking stages.

The quality of the abalone meat is retained because the increased mass is not due to water alone. Rather it is an equilibrium mixture of protein, degraded protein in the form of gelatin and associated salts. Further the gelatin tends to set at room temperature which means that firmness of the meat is retained in the lead up to consumption.

One advantage of the step of reducing the salinity in the holding tanks is that it can be accomplished fairly simply and effectively by pumping fresh water into the closed recirculation system.

An advantage of the blocking step is that the injectors are fairly simple mechanical devices and the blocking material can be made of minced abalone meat. A yet further advantage is that the abalone has only three major blood vessels that all congregate at its neck. These are conveniently positioned adjacent each other and can easily be blocked by an operator in a short space of time.

A yet further advantage is that the step of injecting sorbitol can be carried out fairly simply and quickly by means of a multi-point injector in a single injection step and the injector sites are not visible to the end purchaser.

Another advantage of the method described above is that it can easily be implemented in existing process plants at minimal cost. It readily lends itself to a retro-fit. The reduction in salinity of the water in the holding tanks can be implemented by simply pumping fresh water into the tanks. The blocking and injection steps can be effectively carried out by a skilled operator using a few simple pieces of equipment. The point is they do not require a major investment in surrounding infrastructure.

It will of course be realised that the above has been given only by way of illustrative example of the invention and that all such modifications and variations thereto as would be apparent to persons skilled in the art are deemed to fall within the broad scope and ambit of the invention as herein set forth.

1. A method of processing shellfish at a processing plant after the shellfish have been caught and transferred to land, the method comprising:
receiving a plurality of shellfish at the processing plant;
placing the shellfish in a body of water having a salinity comparable to that of sea water for a first period of time that enables the shellfish to substantially de-stress;
reducing the salinity of the water making up said body of water;
keeping the shellfish in said body of water for a further period of time;
whereby said reduced salinity in said sea water acts to effect an increase in the weight of the meat of said shellfish prior to killing said shellfish and preparing said meat for packing.

2. A method according to claim 1, wherein said shellfish are abalone.

3. A method according to claim 2, wherein said one period of time in said body of water is 30 hours to 100 hours.

4. A method according to claim 2, wherein said period of time is 72 hours to 96 hours.

5. A method according to claim 1, wherein after said one period of time the salinity of said body of water is reduced down to a level of 2.0 to 3.1%.

6. A method according to claim 5, wherein the salinity of said body of water is reduced down to a level of 2.4 to 2.6%.

7. A method according claim 5, wherein the salinity of said body of water is reduced down to 2.4 to 2.6% over a yet further time period of 1 hour to 2 hours.

8. A method according to claim 7, wherein said yet further time period is 1.25 to 1.75 hours.

9. A method according to claim 1, wherein said further period of time for which the shellfish are kept in the body of water of reduced salinity is 10 hours to 30 hours.

10. A method according to claim 9, wherein said further period of time is 20 hours to 26 hours.

11. A method according to claim 1, further including anaesthetising the shellfish after they have boon in said body of water for said further period of time.

12. A method according to claim 11, wherein said shellfish are anaesthetised by one of the following anaesthetics: carbon dioxide, magnesium salts, clove oils, chilli extract or food compatible electric shock treatment.

13. A method according to claim 12, wherein said shellfish are anaesthetised by bubbling food grade carbon dioxide through the water using a fine diffuser.

14. A method according to claim 11, wherein the shellfish are left in said body of water for a period of 0.5 to 1 hours after the anaesthetic is administered to allow the anaesthetic to work before the shellfish are removed from the tank.

15. A method according to claim 1, further including removing each shellfish from the water after all steps in said body of water have been completed and shucking the shellfish to physically detach and separate the meat of the shellfish from the shell and gut.

16. A method according to claim 15, further including closing off at least one major blood vessel so as to resist leakage of fluid out of said shellfish through said blood vessel.

17. A method according to claim 16, wherein said closing off at least one major blood vessel comprises physically blocking said blood vessel or tying a ligature to meat around the vessel or by cauterising the vessel.

18. A method according to claim 17, wherein said blood vessel is blocked by inserting a blocking material into an open end of the blood vessel.

19. A method according to claim 18, wherein the blocking material comprises meat from the same species of shellfish that has been homogenised or minced, or an inert rubber or plastic material.

20. A method according to claim 17, wherein the shellfish is an abalone having three major blood vessels which are close to each other adjacent the neck and all three blood vessels are blocked.

21. A method according to claim 20, wherein open ends of the three vessels are exposed by cutting the neck of the shellfish with a hand held implement in a manual operation prior to being blocked.

22. A method according to claim 21, wherein the step of blocking each blood vessel is carried out by an injector having an end region of reduced diameter relative to the rest of the injector and wherein the injector is capable of injecting blocking material into the blood vessel at high pressure.

23. A method according to claim 15, further including the step of injecting liquid into the meat of the shellfish at at least one injection site after it has been shucked and prior to canning of the meat.

24. A method according to claim 23, wherein the liquid is injected at a plurality of sites spaced 3-5 mm away from each other by an injector having a plurality of spaced injection needles, and the liquid is injected deeply into the meat.

25. A method according to claim 23, wherein the liquid that is injected contains a hygroscopic liquid such as sorbitol.

26. A method according to claim 23, wherein the liquid that is injected contains a humectant liquid selected from one of the following: sorbitol, gelatine, agar and starch.

27. A method according to claim 23, wherein the liquid that is injected has a pH and salt content that promotes the precipitation of gelatinous protein.

28. A method of processing a shellfish having a shell, a gut and a meat or musculature to yield the meat of the shellfish, the method comprising:
providing at least one shellfish for processing;
removing the meat of the shellfish from its associated shell; and
closing off at least one major blood vessel so as to resist leakage of body fluid from said blood vessel.

29. A method according to claim 28, wherein said step of removing the meat from the shellfish comprises manually shucking the shellfish to physically detach and separate the meat of the shellfish from the shell and gut.

30. A method according to claim 29, wherein said closing off at least one major blood vessel comprises physically blocking said blood vessel by inserting a blocking material into an open end of the blood vessel.

31. A method according to claim 30, wherein the shellfish is an abalone having three major blood vessels and each of said major blood vessels is blocked.

32. A method according to claim 28, further including the step of injecting liquid into the meat of the shellfish at at least one injection site after it has been shucked and prior to canning of the meat for distribution and sale.

33. A method of processing abalone meat after it has been shucked and prior to canning of the meat, the method comprising injecting liquid into the meat at at least one injection site.

34. A method of processing abalone meat according to claim 33, wherein the liquid that is injected into the abalone meat is hygroscopic liquid, humectant liquid and/or a salt solution.
